(19) United States
(12) Patent Application Publication
(10) Pub. No.: US 2026/0256266 A1
(43) Pub. Date: Sep. 3, 2026

(54) PLASTIC HINGE SHAFT HAVING ELASTIC DEFORMATION

(71) Applicant: ZHUHAI DING RONG PLASTIC PRODUCTS CO., LTD., GUANGDONG PROVINCE (CN)

(72) Inventor: HUI HUI ZHANG, GUANGDONG PROVINCE (CN)

(21) Appl. No.: 18/852,606

(22) PCT Filed: Aug. 3, 2023
(86) PCT No.: PCT/CN2023/110977

§ 371 Date: Sep. 30, 2024

(51) Int. Cl. A45D 40/22

(52) U.S. Cl. CPC A45D 40/221

(57) ABSTRACT

A plastic cosmetic container having elastic deformation includes a container lid including a knuckle and two aligned first holes through the knuckle; a base including a cavity corresponding to the knuckle, and two aligned second holes through the cavity; and a hinge assembly including two hinge shafts including a groove. The hinge shafts are inserted through the second holes and the first holes to pivotably secure the container lid to the base. The provision of the groove provides a space for accommodating thermal expansion so that a diameter of the hinge shaft does not change. There is no gap between the hinge shaft and each hole. A sufficient friction is generated on the hinge shafts when the container lid is opened. An angle of the open container lid with respect to the base can be kept. Otherwise, the container may close. It increases convenience in use.

### FIELD OF THE INVENTION

The invention relates to plastic hinge shafts and more particularly to a plastic hinge shaft having elastic deformation.

### BACKGROUND OF THE INVENTION

A conventional cosmetic container comprises a container lid including two first holes, a base including two spaced second holes, and two metal pins inserted into the second and first holes respectively to pivotably fasten them together. The damaged cosmetic container can be recycled. But the metal pin, and the container lid and the base both made of plastic are required to recycle separately due to different materials. Otherwise, recycling machines may be damaged in the recycling process and this causes troubles to an operator of the recycling plant.

For solving the above problem, the present inventor invented a conventional cosmetic container comprising a container lid including two first holes, a base including two spaced second hole, and two plastic pins inserted into the second and first holes to pivotably fasten them together. The damaged cosmetic container can be recycled in one process because the pins, the container lid, and the base all are made of plastic.

However, the plastic pins are subject to thermal expansion, i.e., shape change in response to a change of temperature. The pin may expand when temperature rises. The first and second holes may expand accordingly by the expanding pins. To the contrary, the pins may shrink to its original shape when temperature drops. Unfortunately, the first and second holes are permanently deformed, i.e., being larger than their original shapes. There is a gap between each pin and each of the first and second holes when the pins are inserted into the second and first holes. A rotation of the pins of a predetermined degree will not cause the container lid to rotate the same degree due to insufficient friction between the pins and the container lid. It may cause inconvenience in use.

In view of the above, the present inventor has worked deeply on the issues and aggressively searched for a solution based on years' experience in the related field, and through endeavor of repeated study and trial, eventually successfully develops a plastic hinge shaft having elastic deformation in order to overcome or substantially eliminate the drawbacks of the conventional art.

### SUMMARY OF THE INVENTION

It is therefore one object of the invention to provide a plastic hinge shaft having elastic deformation and a simple structure and being easy to operate and repair in order to overcome or substantially eliminate the drawbacks of the conventional art.

For achieving above object, the invention provides a plastic cosmetic container having elastic deformation comprising a container lid including a knuckle extending downward from an edge of an outer surface, and two aligned first holes through two ends of the knuckle respectively; a base configured to close or open the container lid and including a cavity corresponding to the knuckle and being complementary thereto, and two aligned second holes through two ends of the cavity respectively, the second holes being aligned with the first holes; and a hinge assembly including two hinge shafts made of plastic and being cylindrical, each of the hinge shafts including a groove wherein the groove extends from an outer surface of the hinge shaft to an axial center of the hinge shaft, a width of the groove is gradually increased from a bottom to an opening thereof, and the hinge shafts are inserted through the second holes and the first holes to pivotably secure the container lid to the base.

Preferably, the container lid further comprises an opening in a central portion and a mirror fastened in the opening.

Preferably, the base further comprises a recess on a bottom for storing cosmetics.

Preferably, the second hole has a first end distal the cavity and a second end proximate the cavity, the first end having an inner diameter greater than an inner diameter of the second end.

Preferably, the container lid further comprises a male member extending downward from the edge of the outer surface opposite to the knuckle, and the base further comprises a female member disposed on an edge corresponding to the male member, the male member being configured to insert into the female member to be fastened together.

Preferably, the hinge shafts are formed by injection molding.

Preferably, a diameter of the hinge shaft is less than 3.5 mm.

Preferably, a diameter of the hinge shaft is greater than that of each of the first hole and the second hole.

The invention has the following advantages in comparison with the conventional art:

Elastic deformation. The provision of the groove of the hinge shaft provides a space for accommodating thermal expansion. A diameter of the hinge shaft does not change when it is subject to thermal expansion. There is no gap between the hinge shaft and the first hole and there is also no gap between the hinge shaft and the second hole. A sufficient friction is generated on the hinge shafts when the container lid is opened. An angle of the open container lid with respect to the base can be kept due to the sufficient friction. Otherwise, the container lid may fall onto the base. It increases convenience in use.

Wide range of applications. Since the hinge shaft has the same shape and size as that of the conventional metal pin, the hinge shaft can be used to pivotably fasten the container lid and the base of the conventional cosmetic container together. In an assembly of the container lid and the base, the nailing machine for the assembly of the conventional cosmetic container can be used to drive the hinge shaft into the first hole and the second hole rather than using a new nailing machine to do the same job. The plastic hinge shaft of the invention has a wide range of applications.

### BRIEF DESCRIPTION OF THE DRAWINGS

FIG. 1 is a perspective view of a plastic cosmetic container incorporating two plastic hinge shafts according to a preferred embodiment of the invention;

FIG. 2 is an exploded view of the plastic cosmetic container;

FIG. 3 is a perspective view of the plastic hinge shaft according to the preferred embodiment of the invention;

FIG. 4 is a front view of the plastic hinge shaft according to the preferred embodiment of the invention;

FIG. 5 is a perspective view of the base of the plastic cosmetic container; and

FIG. 6 is a sectional view in part section of the plastic cosmetic container showing the base and the container lid being fastened together by the plastic hinge shafts.

### DETAILED DESCRIPTION OF THE INVENTION

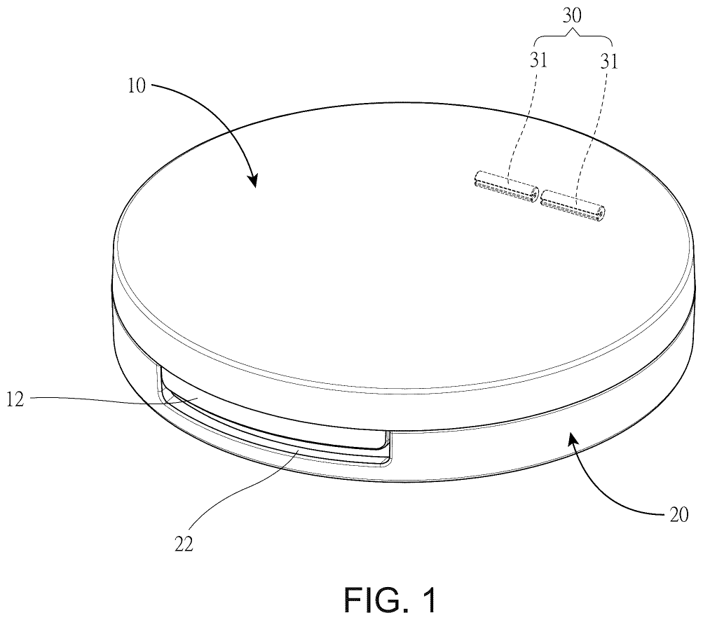

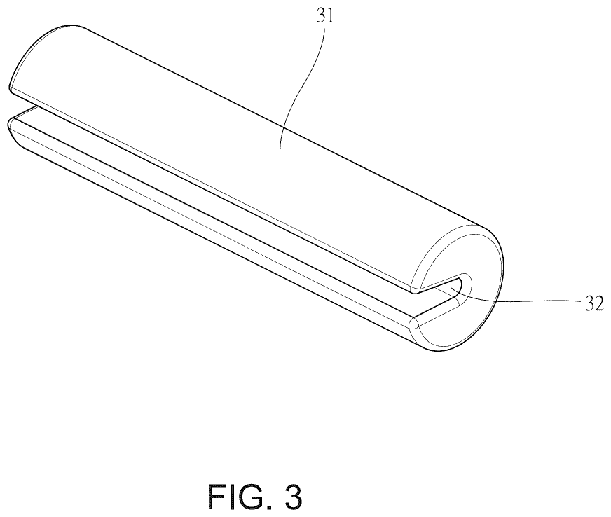

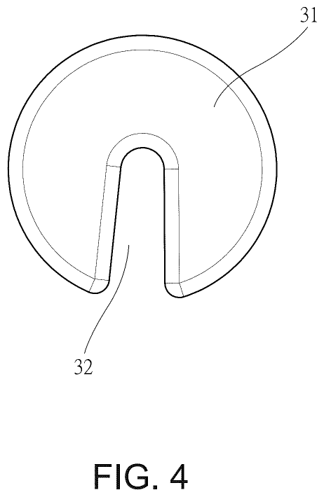

Referring to FIGS. 1 to 6, two plastic hinge shafts having elastic deformation in accordance with the invention are provided in a plastic cosmetic container comprising the following components as discussed in detail below.

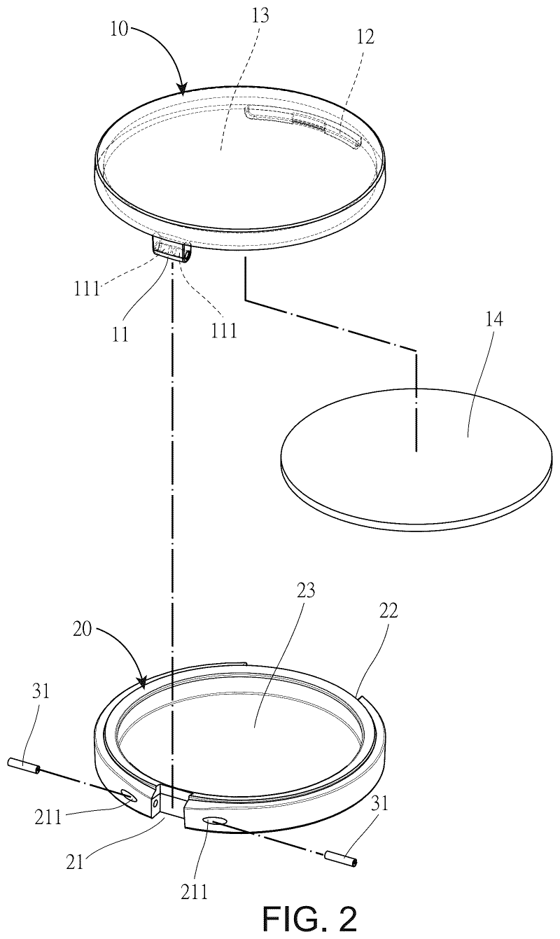

As shown in FIGS. 1 and 2 specifically, the plastic cosmetic container comprises a container lid 10 including a knuckle 11 extending downward from an edge of an outer surface, two aligned first holes 111 through two ends of the knuckle 11 respectively, a male member 12 extending downward from the edge of the outer surface opposite to the knuckle 11, an opening 13 in a central portion of the container lid 10, and a mirror 14 fastened in the opening 13.

The plastic cosmetic container further comprises a base 20 configured to close or open the container lid 10. The base 20 includes a cavity 21 corresponding to the knuckle 11 and being complementary thereto, and two aligned second holes 211 through two ends of the cavity 21 respectively. The first holes 111 are aligned with the second holes 211 when the container lid 10 and the base 20 are put together. The second hole 211 has a first end 212 distal the cavity 21 and a second end 213 proximate the cavity 21. An inner diameter of the first end 212 is greater than that of the second end 213. The base 20 further comprises a female member 22 provided on an edge corresponding to the male member 12. The male member 12 is configured to insert into the female member 22 to be fastened together. A recess 23 is provided on a bottom of the base 20 for storing a cosmetic such as powder, eyeshadow and so on (not shown).

A hinge assembly 30 comprises two hinge shafts 31 made of plastic and being cylindrical. The hinge shaft 31 includes a groove 32 formed by injection molding. The groove 32 extends from an outer surface of the hinge shaft 31 to an axial center of the hinge shaft 31. A width of the groove 32 is gradually increased from a bottom to an opening thereof. The groove 32 is shaped as an U when viewed from either end of the hinge shaft 31. The hinge shafts 31 are inserted through the second holes 211 and the first holes 111 to pivotably secure the container lid 10 to the base 20. A diameter of the hinge shaft 31 is less than 3.5 mm. A diameter of the hinge shaft 31 is slightly greater than that of each of the first hole 111 and the second hole 211. After the hinge shafts 31 have been disposed in the second holes 211 and the first holes 111, a sufficient friction is generated on the hinge shafts 31 when the container lid 10 is opened. Advantageously, an angle of the open container lid 10 with respect to the base 20 can be kept due to the sufficient friction. Otherwise, the container lid 10 may fall onto the base 20 and close same.

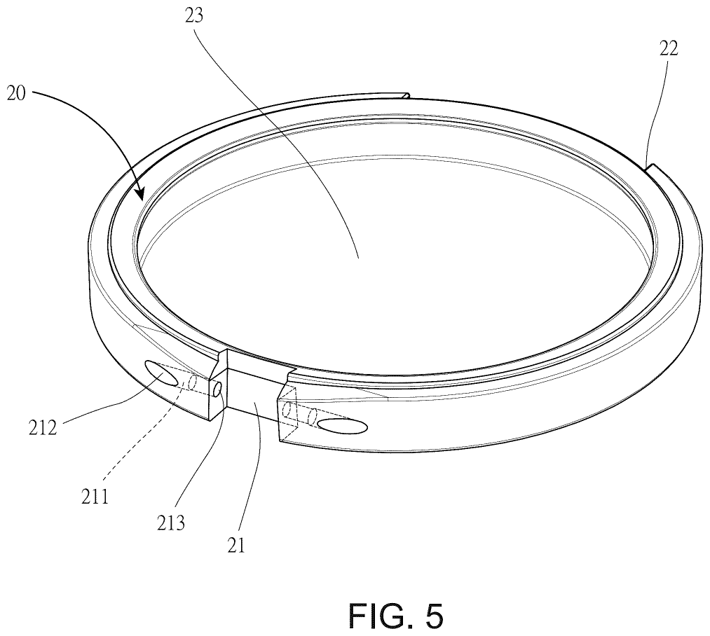

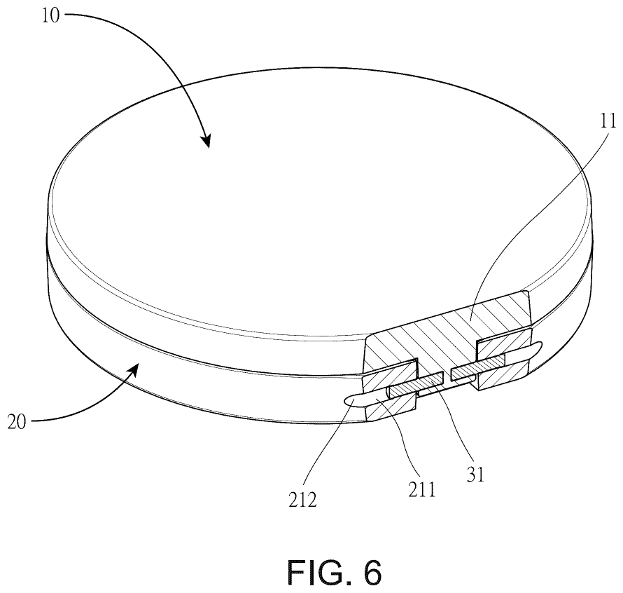

As shown in FIGS. 5 and 6 specifically, each hinge shaft 31 is easily inserted through the first end 212 of the second hole 211 and the second end 213 of the second hole 211 into the first hole 111 because the inner diameter of the first end 212 is greater than that of the second end 213.

As shown in FIGS. 2, 3 and 4 specifically, the provision of the groove 32 of the hinge shaft 31 provides a space for accommodating thermal expansion, i.e., shape change in response to a change of temperature. A diameter of the hinge shaft 31 does not change when it is subject to thermal expansion. Thus, the hinge shaft 31 does not expand both the second holes 211 and the first hole 111. There is no gap between the hinge shaft 31 and the first hole 111 and there is also no gap between the hinge shaft 31 and the second hole 211. A sufficient friction is generated on the hinge shafts 31 when the container lid 10 is opened. Advantageously, an angle of the open container lid 10 with respect to the base 20 can be kept due to the sufficient friction. Otherwise, the container lid 10 may fall onto the base 20 and close same. It increases convenience in use. Moreover, the provision of the groove 32 of the hinge shaft 31 provides a space for accommodating expansion or contraction so that the hinge shaft 31 can be easily inserted through the second hole 211 into the first hole 111.

In the above description, the provision of the groove 32 allows the hinge shaft 31 to have elastic deformation.

It is noted that an assembly of the conventional cosmetic container involves activating a nailing machine (not shown) to drive a metal pin into the second and first holes to pivotably fasten the container lid and the base together. A diameter of the hinge shaft 31 of the invention is less than 3.5 mm. The conventional metal pin can be replaced by the hinge shaft 31 of the invention. In an assembly of the container lid 10 and the base 20, the nailing machine can be used to drive the hinge shaft 31 into the second hole 211 and the first hole 111 rather than using a new nailing machine to do the same job. The plastic hinge shaft of the invention has a wide range of applications. The hinge shaft 31 is sufficiently small so that a joining portion of the hinge shaft 31 and the container lid 10 and a joining portion of the hinge shaft 31 and the base 20 are not required to be larger. Aesthetic appearance of the plastic cosmetic container is greatly increased and the plastic hinge shaft of the invention is applicable to most conventional cosmetic containers.

What is claimed is:

1. A plastic cosmetic container having elastic deformation, comprising:
a container lid including a knuckle extending downward from an edge of an outer surface, and two aligned first holes through two ends of the knuckle respectively;
a base configured to close or open the container lid and including a cavity corresponding to the knuckle and being complementary thereto, and two aligned second holes through two ends of the cavity respectively, the second holes being aligned with the first holes; and
a hinge assembly including two hinge shafts made of plastic and being cylindrical, each of the hinge shafts including a groove wherein the groove extends from an outer surface of the hinge shaft to an axial center of the hinge shaft, a width of the groove is gradually increased from a bottom to an opening thereof, and the hinge shafts are inserted through the second holes and the first holes to pivotably secure the container lid to the base.

2. The plastic cosmetic container having elastic deformation of claim 1, wherein the container lid further comprises an opening in a central portion and a mirror fastened in the opening.

3. The plastic cosmetic container having elastic deformation of claim 1, wherein the base further comprises a recess on a bottom for storing cosmetics.

4. The plastic cosmetic container having elastic deformation of claim 1, wherein the second hole has a first end distal the cavity and a second end proximate the cavity, the first end having an inner diameter greater than an inner diameter of the second end.

5. The plastic cosmetic container having elastic deformation of claim 1, wherein the container lid further comprises a male member extending downward from the edge of the outer surface opposite to the knuckle, and the base further comprises a female member disposed on an edge corresponding to the male member, the male member being configured to insert into the female member to be fastened together.

6. The plastic cosmetic container having elastic deformation of claim 1, wherein the hinge shafts are formed by injection molding.

7. The plastic cosmetic container having elastic deformation of claim 1, wherein a diameter of the hinge shaft is less than 3.5 mm.

8. The plastic cosmetic container having elastic deformation of claim 1, wherein a diameter of the hinge shaft is greater than that of each of the first hole and the second hole.
